(19) United States
(12) Patent Application Publication
(10) Pub. No.: US 2018/0052959 A1
(43) Pub. Date: Feb. 22, 2018

(54) COMPUTER-ASSISTED PERSONNEL SCHEDULING FOR A HEALTH CARE FACILITY

(71) Applicant: KONINKLIJKE PHILIPS N.V., Eindhoven (NL)

(72) Inventors: Reza SHARIFI SEDEH, Malden, MA (US); Yang YANG, Medford, MA (US); Wei WANG, Somerville, MA (US); Yugang JIA, Winchester, MA (US)

(21) Appl. No.: 15/679,259

(22) Filed: Aug. 17, 2017

Related U.S. Application Data
(60) Provisional application No. 62/377,733, filed on Aug. 22, 2016.

(51) Int. Cl. G06F 19/00; G06Q 10/10; G06Q 50/22

(52) U.S. Cl. CPC G06F 19/327; G06Q 50/22; G06Q 10/109

(57) ABSTRACT

The present disclosure pertains to a system configured to facilitate computer-assisted personnel scheduling. The system is configured to: obtain demand information for an individual unit of a health facility, the demand information indicating estimated levels of demand for a service provider at the individual unit during one or more time periods; obtain a rostering model, the rostering model indicating a first unit of time and types of service providers available to be scheduled for respective different multiples of the first unit of time; determine scheduling information for the individual unit based on the rostering model and the demand information, the scheduling information indicating quantities of service providers to be scheduled for the different multiples of the first unit of time during the time periods; and generate, based on the scheduling information, a first interactive element on a user interface that corresponds to the quantities of service providers to be scheduled.

### CROSS-REFERENCE TO PRIOR APPLICATIONS

This application claims the benefit of U.S. Provisional application 62/377733, filed on Aug. 22, 2016. This application is hereby incorporated by reference herein.

### BACKGROUND

### 1. Field

The present disclosure pertains to a system configured to facilitate computer-assisted personnel scheduling.

### 2. Description of the Related Art

Personnel scheduling is a well-known problem within units of health care facilities despite computer-assisted personnel scheduling systems being available. For example, typical computer-assisted personnel scheduling systems suffer from one or more drawbacks, including, but not limited to, (1) being very computationally inefficient, (2) lacking user-friendly interface features, (3) not being efficient in workforce optimization for highly variant staffing demands (e.g., nurse demands in emergency departments), and/or (4) not being able to optimize for preferences for personnel with specific shift lengths. All of the foregoing may, for instance, result in poor user experience with such computer-assisted personnel scheduling systems.

### SUMMARY

Accordingly, one or more aspects of the present disclosure relate to a system configured to facilitate computer-assisted personnel scheduling. The system comprises one or more hardware processors and/or other components. The one or more hardware processors are configured by machine-readable instructions to: obtain demand information for an individual unit of a health facility, the demand information indicating one or more estimated levels of demand for a service provider at the individual unit during one or more time periods, and the one or more estimated levels of demand being based on past patient census information indicating one or more quantities of patient visits to the individual unit with respect to one or more past time periods; obtain a rostering model, the rostering model indicating a first unit of time and types of service providers available to be scheduled for respective different multiples of the first unit of time; determine scheduling information for the individual unit based on the rostering model and the demand information, the scheduling information indicating one or more quantities of service providers to be scheduled for at least one of the different multiples of the first unit of time during the one or more time periods; and generate, based on the scheduling information, a first interactive element on a user interface, the first interactive element corresponding to the one or more quantities of service providers to be scheduled.

Yet another aspect of the present disclosure relates to a method for facilitating computer-assisted personnel scheduling. The method is implemented by one or more hardware processors configured by machine readable instructions and/or other components. The method comprises: obtaining demand information for an individual unit of a health facility, the demand information indicating one or more estimated levels of demand for a service provider at the individual unit during one or more time periods, and the one or more estimated levels of demand being based on past patient census information indicating one or more quantities of patient visits to the individual unit with respect to one or more past time periods; obtaining a rostering model, the rostering model indicating a first unit of time and types of service providers available to be scheduled for respective different multiples of the first unit of time; determining scheduling information for the individual unit based on the rostering model and the demand information, the scheduling information indicating one or more quantities of service providers to be scheduled for at least one of the different multiples of the first unit of time during the one or more time periods; and generating, based on the scheduling information, a first interactive element on a user interface, the first interactive element corresponding to the one or more quantities of service providers to be scheduled.

Still another aspect of the present disclosure relates to a system for facilitating computer-assisted personnel scheduling. The system comprises: means for obtaining demand information for an individual unit of a health facility, the demand information indicating one or more estimated levels of demand for a service provider at the individual unit during one or more time periods, and the one or more estimated levels of demand being based on past patient census information indicating one or more quantities of patient visits to the individual unit with respect to one or more past time periods; means for obtaining a rostering model, the rostering model indicating a first unit of time and types of service providers available to be scheduled for respective different multiples of the first unit of time; means for determining scheduling information for the individual unit based on the rostering model and the demand information, the scheduling information indicating one or more quantities of service providers to be scheduled for at least one of the different multiples of the first unit of time during the one or more time periods; and means for generating, based on the scheduling information, a first interactive element on a user interface, the first interactive element corresponding to the one or more quantities of service providers to be scheduled.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 is a schematic illustration of a system configured to facilitate computer-assisted personnel scheduling, in accordance with one or more embodiments.

FIG. 2 illustrates an example user interface with user interface elements for facilitating computer-assisted personnel scheduling, in accordance with one or more embodiments.

FIG. 3 illustrates a method for facilitating computer-assisted personnel scheduling, in accordance with one or more embodiments.

### DETAILED DESCRIPTION OF EXEMPLARY EMBODIMENTS

As used herein, the singular form of “a”, “an”, and “the” include plural references unless the context clearly dictates otherwise. As used herein, the term “or” means “and/or” unless the context clearly dictates otherwise. As used herein, the statement that two or more parts or components are “coupled” shall mean that the parts are joined or operate together, either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example, and without limitation, top, bottom, left, right, upper, lower, front, back, and derivatives thereof, relate to the orientation of the elements shown in the drawings and are not limiting upon the claims unless expressly recited therein.

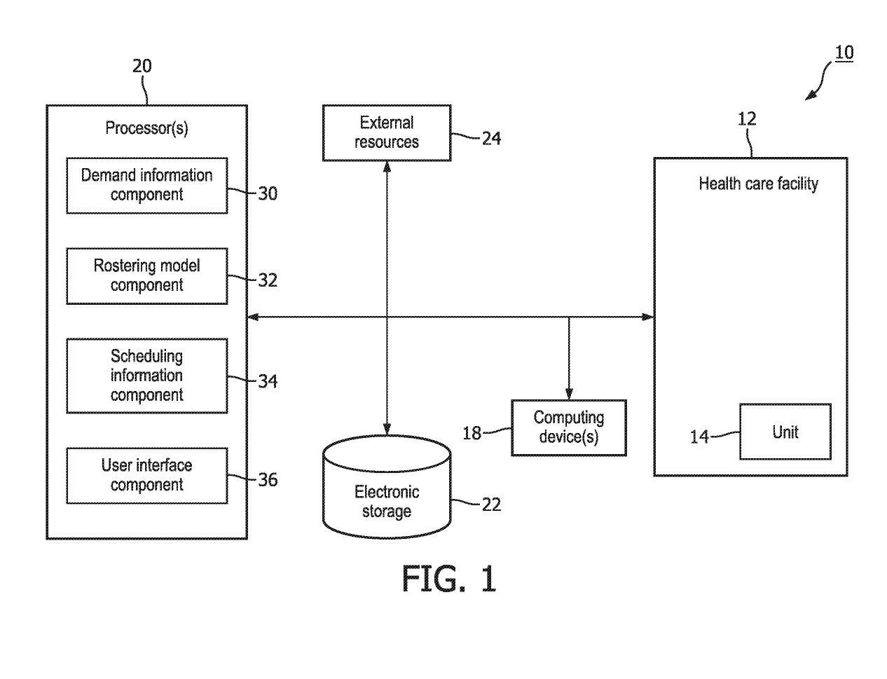

FIG. 1 illustrates a system 10 configured to facilitate computer-assisted personnel scheduling, in accordance with one or more embodiments. In some embodiments, system 10 is configured to facilitate allocation of staffing resources based on an estimated demand for the staffing resources. In some embodiments, system 10 is configured to facilitate such allocation of staffing resources to address one or more drawbacks described herein with respect to typical computer-assisted personnel scheduling systems.

In some embodiments, system 10 is configured to determine scheduling information for a unit (e.g., a unit of a health care facility or other unit) based on a rostering model and demand information for the unit, and generate one or more elements on a user interface that correspond to one or more quantities of service providers to be scheduled (or suggested for scheduling). As an example, the scheduling information may indicate the quantities of service providers to be scheduled (to which one or more of the user interface elements correspond). The demand information may indicate one or more estimated levels of demand for a service provider at the unit during one or more time periods. The rostering model may indicate a first unit of time, types of service providers available to be scheduled for respective different multiples of the first unit of time, or other information. In this way, for example, system 10 may provide more computationally efficient computer-assisted personnel scheduling via the use of the rostering model which may allow for use of computationally inexpensive instructions in lieu of one or more computationally expensive instructions (e.g., use of instructions using addition or subtraction operands in lieu of one or more instructions using multiplication or division operands or use of other less computationally expensive instructions).

In some embodiments, system 10 may generate one or more interactive elements on a user interface that correspond to quantities of service providers to be scheduled, estimated levels of demand for a service provider, or other aspects related to personnel scheduling as described herein, for example, to provide improved user interface features, compared with those of typical computer-assisted personnel scheduling systems.

In some embodiments, system 10 may estimate levels of demand for a service provider based on past patient census information (e.g., statistically) with the target of allocating service providers such that low quality of care problems are avoided due to understaffing and such that budget overruns are avoided due to overstaffing. System 10 may also avoid quality of care problems by preferring personnel who work longer shifts (e.g., preferring twelve hour shifts over eight or four hour shifts and preferring eight hour shifts over four hour shifts). Such preference may be an aspect of a rostering model used to schedule the personnel. The rostering model may be selected from among a plurality of rostering models.

In some embodiments, based on a particular rostering model, system 10 may allocate service providers that work the longest shifts and then, after these service providers are allocated, service providers that work shorter shifts may be allocated, followed by allocation of service providers who work even shorter shifts. Such selection of a rostering model creates a strict constraint in performing personnel allocation. Such approach may, for example, be utilized to satisfy one or more understaffing or overstaffing constraints (e.g., within 0.5 full-time-equivalent (FTE) or other constraints).

In some embodiments, the rostering model may be defined by the type of service providers allocable. Regardless of the selected rostering model, some embodiments may be able to satisfy a quality factor (e.g., service recipient to service provider ratio, such as a patient to nurse ratio or other ratio) while also satisfying understaffing/overstaffing thresholds. In some implementations, the quality factor may be determined by established guidelines for unit 14, policy of health care facility 12, or one or more laws or regulations of a jurisdiction of unit 14 or of health care facility 12. In some embodiments, the quality factor and understaffing/overstaffing thresholds may be user configurable (e.g., supplied by a user via the user interface of computing device 18).

The description and illustration herein (FIG. 1) of a single unit 14 in a single health care facility 12 is not intended to be limiting. Health care facility 12 may represent any number of health care facilities and unit 14 may represent any number of units within any number of health care facilities 12. The operations performed by system 10 are applied individually to any number of units 14 in any number of facilities 12. The operations performed by system 10 may be simultaneous for different units 14 and/or performed at different times. For example, system 10 may receive past patient census information for a plurality of units 14 (e.g., from the same health care facility 12 and/or from different health care facilities 12) and carry out the operations described herein for the plurality of units at the same time. In some embodiments, health care facilities 12 include health care management systems, hospitals, hospital systems, doctor's offices, collections of doctor's offices, and/or other health care facilities. Units 14 may include departments within care management systems and/or hospitals (e.g., an emergency department, an imaging department, a laboratory, a surgical department, a maternity department, a pediatric department, a trauma department, a general department, a psychiatric department, a coronary department, and/or other departments), different types of doctor's offices (e.g., family practitioners, pediatricians, orthopedic doctors, cardiologists, oncologists, geriatric doctors, and/or doctor's with other medical specialties), and/or other units.

In some embodiments, system 10 comprises one or more computing devices 18, one or more processors 20, electronic storage 22, external resources 24, and/or other components. Computing devices 18 are configured to provide an interface between users and system 10. In some embodiments, computing devices 18 are associated with health care facility 12, unit 14, and/or other entities; service providers associated with or participating in health care facility 12 and/or unit 14; and/or other users and/or entities. Service providers may be nurses, paramedics, caregivers, medical consultants, or any provider of service associated with a health care facility. Computing devices 18 are configured to provide information to and/or receive information from such users and/or entities. Computing devices 18 include a user interface and/or other components. The user interface may be and/or include a graphical user interface configured to present views and/or fields configured to receive entry and/or selection of patient census information, rostering model information, understaffing/overstaffing threshold information, present information related to unit classifications of units such as unit 14 and/or other units, present computer simulations of patient demand, and/or provide and/or receive other information. In some embodiments, the user interface includes a plurality of separate interfaces associated with a plurality of computing devices 18, processors 20, and/or other components of system 10, for example.

In some embodiments, one or more computing devices 18 are configured to provide a user interface, processing capabilities, databases, and/or electronic storage to system 10. As such, computing devices 18 may include processors 20, electronic storage 22, external resources 24, and/or other components of system 10. In some embodiments, computing devices 18 are connected to a network (e.g., the Internet). In some embodiments, computing devices 18 do not include processor 20, electronic storage 22, external resources 24, and/or other components of system 10, but instead communicate with these components via the network. The connection to the network may be wireless or wired. For example, processor 20 may be located in a remote server and may wirelessly receive the patient census information from health care facility 12 and/or unit 14, and/or cause display of the computer-simulated patient demand via the user interface on a computing device 18 associated with health care facility 12 and/or unit 14. In some embodiments, computing devices 18 are laptops, desktop computers, smartphones, tablet computers, smart watches, and/or other computing devices.

Examples of interface devices suitable for inclusion in the user interface include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that computing devices 18 include a removable storage interface. In this example, information may be loaded into computing devices 18 from removable storage (e.g., a smart card, a flash drive, a removable disk) that enables users to customize the implementation of computing devices 18. Other exemplary input devices and techniques adapted for use with computing devices 18 and/or the user interface include, but are not limited to, an RS-232 port, RF link, an IR link, a modem (telephone, cable, etc.) and/or other devices.

Processor 20 is configured to provide information processing capabilities in system 10. As such, processor 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some embodiments, processor 20 may comprise a plurality of processing units. These processing units may be physically located within the same device (e.g., a server), or processor 20 may represent processing functionality of a plurality of devices operating in coordination (e.g., one or more servers, computing devices 18, devices that are part of external resources 24, electronic storage 22, and/or other devices.)

In some embodiments, processor 20, external resources 24, computing devices 18, electronic storage 22, systems that are part of health care facility 12 and/or unit 14, and/or other components may be operatively linked via one or more electronic communication links. For example, such electronic communication links may be established, at least in part, via a network such as the Internet, and/or other networks. It will be appreciated that this is not intended to be limiting, and that the scope of this disclosure includes embodiments in which these components may be operatively linked via some other communication media. In some embodiments, processor 20 is configured to communicate with external resources 24, computing devices 18, electronic storage 22, the systems that are part of health care facility 12 and/or unit 14, and/or other components according to a client/server architecture, a peer-to-peer architecture, and/or other architectures.

As shown in FIG. 1, processor 20 is configured via machine-readable instructions to execute one or more computer program components. The computer program components may comprise one or more of a demand information component 30, a rostering model component 32, a scheduling information component 34, a user interface component 36, and/or other components. Processor 20 may be configured to execute components 30, 32, 34, and/or 36 by: software; hardware; firmware; some combination of software, hardware, and/or firmware; and/or other mechanisms for configuring processing capabilities on processor 20.

It should be appreciated that although components 30, 32, 34, and 36 are illustrated in FIG. 1 as being co-located within a single processing unit, in embodiments in which processor 20 comprises multiple processing units, one or more of components 30, 32, 34, and/or 36 may be located remotely from the other components. The description of the functionality provided by the different components 30, 32, 34, and/or 36 described below is for illustrative purposes, and is not intended to be limiting, as any of components 30, 32, 34, and/or 36 may provide more or less functionality than is described. For example, one or more of components 30, 32, 34, and/or 36 may be eliminated, and some or all of its functionality may be provided by other components 30, 32, 34, and/or 36. As another example, processor 20 may be configured to execute one or more additional components that may perform some or all of the functionality attributed below to one of components 30, 32, 34, and/or 36.

In some embodiments, demand information component 30 is configured to obtain demand information for an individual unit of a health care facility. In some embodiments, the demand information indicates one or more estimated levels of demand for service providers at the individual units during one or more time periods (e.g., weeks or other time periods). In some embodiments, the demand information is based on past patient census information. The past patient census information may indicate one or more quantities of patient visits to the individual unit with respect to one or more past time periods (e.g., past weeks or other past time periods). As an example, a quantity of patient visits to unit 14 during past periods of time may comprise an hourly (and/or other time-based metric) quantity of patient visits to unit 14 over the past time periods.

In some embodiments, demand information component 30 is configured to obtain the demand information from servers and/or other databases associated with health care facility 12 and/or unit 14, servers and/or databases included in external resources 24, electronic storage 22, and/or from other sources. The demand information may be different for each different unit of a health care facility.

In some embodiments, demand information component 30 is configured to determine the demand information based on the past patient census information. In some embodiments, demand information component 30 is configured to obtain the past patient census information from servers and/or other databases associated with health care facility 12 and/or unit 14, servers and/or databases included in external resources 24, electronic storage 22, and/or from other sources. In some embodiments, the past patient census information is a part of information typically recorded via computing devices 18 and/or other electronic systems associated with unit 14 and/or health care facility 12. In some embodiments, demand information component 30 is configured to obtain week by week past patient census information going back in time for a period of years (e.g., two years or more). For example, unit 14 may electronically record when a patient visits unit 14 for an appointment and/or for other reasons (e.g., an emergency) via a computing device 18 operated by a staff member of unit 14. The past patient census information may include recordings of a series of such visits over time (minutes, hours, days, weeks, months, years) by any number of individual patients to unit 14. As an example, demand information component 30 may calculate averages of the levels of past demand over respective consecutive past four-hour periods (or other given periods) to determine the demand information. In one use case, the past levels of demand for a service provider (e.g., nurse or other service provider) for a given four-hour period on the first Mondays in February over the last few years may be averaged to determine an estimated level of demand for the given four-hour period for a future first Monday of February. If, for instance, there are four values (f1, f2, f3, and f4) representing the past levels of demand for a service provider for the respective four-hour periods, the average of the four values may be calculated by using addition operands to sum the four values and a division operand to divide the sum by four (e.g., average (f1,f2,f3 and f4)=(f1+f2+f3+f4)/4)).

In some embodiments, demand information component 30 may generate a demand chart. As an example, the demand chart may include (i) historical averages of service provider demand at unit 14, (ii) quantities of service providers required to satisfy an industry standard, a certain quality standard, laws for staffing at hospitals in a given country, or other standard, (iii) predicted service provider demand at unit 14 (e.g., based on patient appointments or other considerations), or (iv) other information.

In some embodiments, demand information component 30 is configured to impute missing information and remove outliers from the obtained past patient census information. Demand information component 30 may be further configured to remove data from the obtained past patient census information to account for irregularities (such as holidays, holiday weeks, and/or doctors' vacations), conduct a change-point analysis that selects the latest ten weeks (and/or any other number and/or time period that allows system 10 to function as described herein) of past patient census information for analysis by scheduling information component 34, and/or to perform other data pre-processing operations. The imputation of missing information and removal of outliers from the obtained past patient census information may be performed with standard imputation algorithms and/or outlier detection procedures, and/or other techniques. Information for holidays and/or holiday weeks may be removed from the obtained past patient census information because holidays and doctors' vacations create turbulences in patient census patterns and/or for other reasons. For example, a Monday holiday, such as Labor Day and/or Memorial Day in the U.S.A., may effectively push Monday patient visits in unit 14 to Tuesday. A Thursday holiday, such as Thanksgiving in the U.S.A., pushes patient visits to either Wednesday or the following Monday.

In some embodiments, demand information component 30 is configured to receive as input, from the user via a user interface, holidays and other special events. In some embodiments, demand information component 30 may use such inputs to modify obtained demand information (e.g., to better align the demand information with expected demand levels in the future). In some embodiments, demand information component 30 may provide to scheduling information component 34 various days in one or more time periods as blocked out days such that service providers are not allocated to work during those blocked out days.

In some embodiments, demand information component 30 is configured to account for peak times in units. For example, certain medical units (e.g., surgery unit or facility) or health care facilities may schedule personnel to cover for peak demand at certain times (e.g., in the morning) during the time periods. Demand information component 30 may adjust a target service recipient to service provider ratio (e.g., a patient to nurse ratio or other ratio), which scheduling information component 34 operates on to cover the peak times (e.g., the number of service providers allocated meets the service provider demand during the peak times).

In some embodiments, rostering model component 32 is configured to obtain a rostering model. In some embodiments, the rostering model indicates a first unit of time, types of service providers available to be scheduled for respective different multiples of the first unit of time, or other indications. In some embodiments, the first unit of time is greater than one hour and less than one day. As an example, the first unit of time may be four hours. A service provider of a first service provider type may be a service provider that is available to be scheduled for four consecutive hours. A service provider of a second service provider type may be a service provider that is available to be scheduled for twelve consecutive hours. A service provider of a third service provider type may be a service provider that is available to be scheduled for eight consecutive hours. It should be noted that the foregoing example is not intended to be limited, and it is contemplated that the first unit of time (or other unit of time) indicated by the rostering model may be another amount of time (e.g., a different number of hours, a certain number of days, or other amount of time), and the service provider types indicated by the rostering model may be multiples of the first unit of time that are different from the foregoing example.

In some embodiments, rostering model component 32 is configured to obtain the rostering model by selecting the rostering model from among other rostering models (e.g., as indicated by a user or as is predetermined for use). For example, in one rostering model, service providers of the first service provider type, second service provider type, and third service provider type may be available for scheduling. In another rostering model, only service providers of the second and third service provider types may be available for scheduling. In still another rostering model, only service providers of the second service provider type or of the third service provider type may be available for scheduling. Some embodiments may support only one rostering model. Other embodiments may support multiple different rostering models.

In some embodiments, scheduling information component 34 is configured to determine scheduling information for unit 14 based on the rostering model, the demand information, and/or other information. Scheduling information may indicate one or more quantities of service providers to be scheduled for at least one of the different multiples of the first unit of time during the time periods (for which the levels of demand are estimated), the specific service providers that are to be scheduled (for the different multiples of the first unit of time) during the time periods, and/or other information.

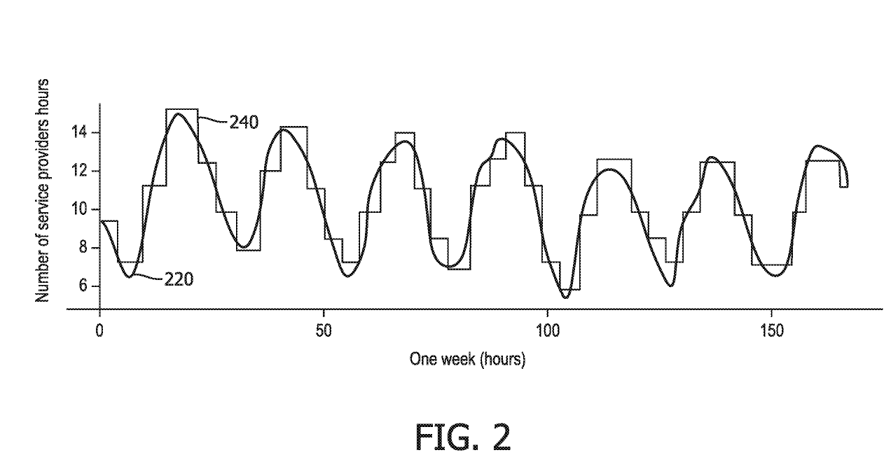

In some embodiments, user interface component 36 is configured to receive, via a user interface, user input indicating one or more starting times, end times, or other times for one or more time periods for which service providers are to be scheduled. As an example, user input received via the user interface may indicate a starting time (e.g., a particular hour, day, or other starting time) from which to begin scheduling personnel for each of the time periods. In one use case, with respect to FIG. 2, based on a user's input specifying the starting time, demand line 220 and supply line 240 may be generated on a chart to begin from the user-inputted starting time, where demand line 220 corresponds to the estimated levels of hourly demand for a service provider for a week, and supply line 240 corresponds to the quantities of service providers to be scheduled (or suggested to be scheduled).

In some embodiments, scheduling information component 34 is configured to allocate service providers of a first service provider type across the time periods (for which the levels of demand are estimated) based on the demand information (indicating the estimated levels of demand). In some embodiments, scheduling information component is configured to allocate service providers of the first type across the time periods such that a quantity of allocated service providers of the first service provider type satisfies the estimated levels of demand during the time periods. As an example, the first service provider type may be a service provider that is available to be scheduled for a first multiple of the first unit of time. In some embodiments, scheduling information component 34 is configured to allocate the first-type service providers based on the rostering model (e.g., based on its indication that a service provider of the first service provider type is available for scheduling). In some embodiments, the allocated quantity of service providers of the first service provider type satisfies the estimated levels of demand during the time periods responsive to the allocated quantity being within an understaffing threshold and an overstaffing threshold. In some embodiments, the thresholds may be predefined. In some embodiments, the thresholds may be user-configurable.

In some embodiments, scheduling information component 34 may consider a particular skill level demanded of service providers. For example, the obtained demand information may indicate that a high skill level service provider is expected to be needed in an upcoming time period. In these embodiments, scheduling information component 34 may allocate service providers of the required skill level in the required time period without reducing the effectiveness in allocating other service providers. Different types of service providers, differentiated by a characteristic other than skill or a number of hours to be worked, are also contemplated by the present disclosure and allocated accordingly.

In some embodiments, scheduling information component 34 is configured to replace consecutive allocations of service providers of the first service provider type with a service provider of a second service provider type. As an example, the second service provider type may be a service provider that is available for a second multiple of the first unit of time different than the first multiple of the first unit of time. In one use case, the first unit of time may be four hours, a first-type service provider may be a service provider that is available to be scheduled for four consecutive hours, and a second-type service provider may be a service provider that is available to be scheduled for twelve consecutive hours. In another use case, the first unit of time may be four hours, a first-type service provider may be a service provider that is available to be scheduled for four consecutive hours, and a second-type service provider may be a service provider that is available to be scheduled for eight consecutive hours. In some embodiments, scheduling information component 34 is configured to replace consecutive allocations of first-type service providers with second-type service providers based on the rostering model (e.g., based on its indication that a service provider of the second service provider type is available for scheduling). In some embodiments, scheduling information component 34 is configured to iteratively replace consecutive allocations of first-type service providers with a second-type service provider. As an example, scheduling information component 34 may continue to replace consecutive allocations of first-type service providers in a time period with a second-type service provider until the remaining consecutive allocations of first-type service providers in the time period cannot be replaced with a second-type service provider. In one scenario, for example, if all three consecutive allocations of four-hour shift nurses in a time period have been replaced by twelve-hour shift nurses, schedule information component 34 may stop performing the iterative replacement of consecutive four-hour shift nurses with twelve-hour shift nurses.

In some embodiments, scheduling information component 34 is configured to replace one or more remaining consecutive allocations of service providers of the first service provider type with a service provider of a third service provider type (e.g., the remaining consecutive allocations that have not been replaced after the replacement with a service provider of the second service provider type). As an example, the third service provider type may be a service provider that is available for a third multiple of the first unit of time different than the first multiple of the first unit of time and the second multiple of the first unit of time. In some embodiments, scheduling information component 34 is configured to replace the remaining consecutive allocations of first-type service providers with third-type service providers based on the rostering model (e.g., based on its indication that a service provider of the third service provider type is available for scheduling). In some embodiments, scheduling information component 34 is configured to iteratively replace the remaining consecutive allocations of service providers of the first service provider type with a service provider of the third service provider type. In one use case, the first unit of time may be four hours, a service provider of the first service provider type may be a service provider that is available to be scheduled for four consecutive hours, and a service provider of the second service provider type may be a service provider that is available to be scheduled for twelve consecutive hours. In a further use case, a service provider of the third service provider type may be a service provider that is available to be scheduled for eight consecutive hours. After completing the iterative replacement of consecutive allocations of four-hour service providers with a twelve-hour service provider (e.g., replacement of every three consecutive allocations of four-hour service providers with a twelve-hour service provider in a time period), scheduling information component 34 may begin iteratively replacing the remaining consecutive allocations of four-hour service providers with eight-hour service providers.

In some embodiments, after the iterative replacement of remaining consecutive allocations of first-type service providers with third-type service providers, scheduling information component 34 is configured to replace one or more further remaining consecutive allocations of first-type service providers with one or more service providers of one or more other service provider types (e.g., the remaining consecutive allocations that have not been replaced after the replacement with a third-type service provider) based on the rostering model indicating that service providers of the other service providers types (other than the first, second, and third service provider types) are available to be scheduled.

In some embodiments, scheduling information component 34 is configured to determine quantities of service providers to be scheduled for at least one of the different multiples of the first unit of time during at least a portion of the time periods (for which levels of demand are estimated) without using multiplication operands and/or without using division operands. In some embodiments, scheduling information component 34 is configured to use one or more addition or subtraction operands to determine the quantities of service providers to be scheduled during at least a portion of the time periods without using multiplication operands and/or without using division operands. In this way, for example, determination of the quantities of service providers (to be scheduled during at least a portion of the time periods) may be performed without the computationally expensive and time consuming multiplication and/or division operands. As an example, one or more portions of the allocations of service providers and/or the replacement of the allocations described herein may be performed using one or more addition or subtraction operands without the need for multiplication and/or division operands (e.g., due to the manner in which the unit(s) of time and service provider types are defined in the rostering model and/or other considerations), thereby decreasing computational costs and increasing performance (e.g., due to the simpler and faster addition and subtraction operands). It should be noted that, in some embodiments, although allocations of service providers and/or replacements of the allocations described herein may be performed without multiplication operands and without division operands, one or more multiplication and/or division operands may be used to perform one or more other operations (e.g., determining one or more estimated levels of demand for a service provider at the individual unit during one or more time periods or other operations).

In some embodiments, scheduling information component 34 is configured to determine quantities of service providers to be scheduled for at least one of the different multiples of the first unit of time during at least a portion of the time periods (for which levels of demand are estimated) without using mixed-integer programming or any other complex optimization algorithms. As an example, one or more portions of the allocations of service providers and/or the replacement of the allocations described herein may be performed without the need for mixed-integer programming or any other complex optimization algorithms (e.g., due to the manner in which the unit(s) of time and service provider types are defined in the rostering model and/or other considerations), thereby decreasing computational costs and increasing performance. It should be noted that, in some embodiments, although allocations of service providers and/or replacements of the allocations described herein may be performed without the need for mixed-integer programming or any other complex optimization algorithms, such complex optimization algorithms may be used to perform one or more other operations.

In some embodiments, user interface component 36 is configured to generate a first interactive element, a second interactive element, or other elements on a user interface. In some embodiments, user interface component 36 is configured to generate the first interactive element based on the scheduling information. In some embodiments, user interface component 36 is configured to generate the second interactive element based on the demand information (indicating the estimated levels of demand). As an example, the first interactive element may correspond to the quantities of service providers to be scheduled (indicated in the scheduling information). The second interactive element may correspond to the estimated levels of demand (indicated in the demand information).

In some embodiments, the first and/or second interactive elements may not be moveable. As an example, these elements may include non-movable textual input fields, icons (e.g., an arrow or +/− signs) on a display, and other interactive elements. In one use case, a user may specify one or more inputs at the user interface, such as a percent increase or decrease in the estimated levels of demand or in the determined supply. Additionally, or alternatively, a user may activate (e.g., click or touch) an icon (or button) on the user interface to incrementally adjust the demand or supply.

In some embodiments, user interface component 36 is configured to generate the first interactive element on the user interface such that the first interactive element is moveable by a user from a current position of the first interactive element on the user interface to another position on the user interface. In some embodiments, user interface component 36 is configured to generate a second interactive element on the user interface such that the second interactive element is moveable by a user from a current position of the second interactive element on the user interface to another position on the user interface.

As an example, with respect to FIG. 2, the first interactive element may be supply line 240, the second interactive element may be demand line 220, and the demand line 220 and/or the supply line 240 may be moveable by a user (e.g., moveable up, down, left, or right on the chart). In one scenario, responsive to movement of the first interactive element, the second interactive element, or other interactive elements, the estimated levels of demand and/or the quantities of service providers to be scheduled (or suggested to be scheduled) may be adjusted. In another scenario, such adjustments may result in the addition of more service providers, the removal of allocated service providers, and/or the replacement of one type of service provider with another type of service provider.

In some implementations, including those where the demand information is represented as a demand line (e.g., curve or other line), movement of one or more interactive elements or other user input may indicate a multiplier. For example, the user may indicate that the estimated demand (e.g., for a special event) should be higher or lower based on the indicated multiplier. For example, if the user input specifies a +10% increase then a multiplier of 1.1 may be used to adjust the represented demand chart. This user input for the +10% adjustment may be in the form of text or a drag option (e.g., with a finger on a touchpad or by using a computer mouse). With respect to FIG. 2, for example, by dragging and adjusting demand line 220, the user may make an adjustment for a single day, week, month, or other time period.

In some embodiments, scheduling information component 34 may be configured to update the scheduling information responsive to the first interactive element being moved to another position on the user interface, the second interactive element being moved to another position on the user interface, or other user interaction. As an example, responsive to movement of the first interactive element, the second interactive element, or other interactive elements, the estimated levels of demand and/or the quantities of service providers to be scheduled (or suggested to be scheduled) may be adjusted. As another example, such adjustments may result in the addition of more service providers, the removal of allocated service providers, and/or the replacement of one type of service provider with another type of service provider. In one use case, with respect to FIG. 2, dragging portions of demand line 220 toward the bottom of the chart may indicate a lower estimated level of demand, and dragging portions of demand line 220 upwards away from the bottom of the chart may indicate a higher estimated level of demand. In another use case, dragging portions of supply line 240 toward the bottom of the chart may indicate a lower quantity of service providers to be scheduled, and dragging portions of supply line upwards away from the bottom of the chart may indicate a higher quantity of service providers to be scheduled.

In some embodiments, user interface component 36 is configured to provide to demand information component 30 any received user input pertaining to holidays and/or other special events, as described above, for more accurate estimation of demand information that needs to be covered by the service providers. Some embodiments may re-optimize scheduling information as a result of user adjustments (e.g., adding a holiday that results in decreased demand for service providers or accounting for a special event that leads to an increased demand).

In some embodiments, user interface component 36 may receive user input that adjusts one of the quality factors used in scheduling personnel. For example, one parameter set by user input may require service providers to be allocated to cover the estimated demand within an understaffing and overstaffing threshold of 0.5 FTE. This parameter is not intended to be limiting and any suitable threshold may be set. For example, an adjustment to that parameter may result in an understaffing or overstaffing within 1.5 FTE.

In some embodiments, schedule information component 34 is configured to update at least a portion of the scheduling information without using multiplication operands and/or without using division operands. In some embodiments, scheduling information component 34 is configured to use one or more addition or subtraction operands to update at least some of the quantities of service providers to be scheduled during the time periods without using multiplication operands and/or without using division operands. In this way, for example, the updating of at least some of the quantities of service providers (to be scheduled during the time periods) may be performed without the computationally expensive multiplication and/or division operands. As an example, one or more portions of the allocations of service providers and/or the replacement of the allocations described herein may be performed to update the scheduling information using one or more addition or subtraction operands without the need for multiplication and/or division operands (e.g., due to the manner in which the unit(s) of time and service provider types are defined in the rostering model and/or other considerations). For example, when determining the scheduling information, some embodiments may not need to divide the number of hours demanded (in the demand information) by the number of first-type service providers, second-type service providers, and/or third-type service providers.

In some embodiments, user interface component 36 may receive user input that adjusts the starting time or anchor point for estimating demand and scheduling the supply. In these or other embodiments, the starting time or anchor point may be based on a present time the user is interacting with user interface component 36.

In some embodiments, user interface component 36 may receive user input that adjusts a service recipient to service provider ratio, which may lead to an increased or decreased demand. For example, if the prior or default parameter was 4 patients for every 1 nurse (i.e., a ratio of 4/1) and if the user adjusts this parameter to 3 patients for every 1 nurse (an increased demand), then schedule information component 34 may allocate a greater amount of service provider hours to cover the increased demand. This ratio may be adjusted due to varying levels of desired or permissible health care quality.

Returning to FIG. 1, electronic storage 22 comprises electronic storage media that electronically stores information. The electronic storage media of electronic storage 22 may comprise one or both of system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 22 may be (in whole or in part) a separate component within system 10, or electronic storage 22 may be provided (in whole or in part) integrally with one or more other components of system 10 (e.g., a computing device 18, processor 20, etc.). In some embodiments, electronic storage 22 may be located in a server together with processor 20, in a server that is part of external resources 24, in computing devices 18, and/or in other locations. Electronic storage 22 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 22 may store software algorithms, information obtained and/or determined by processor 20, information received via computing devices 18 and/or other external computing systems, information received from external resources 24, information received from heath care facility 12 and/or unit 14, and/or other information that enables system 10 to function as described herein. By way of a non-limiting example, electronic storage 22 may store the patient census information obtained by demand information component 30, the rostering models used by rostering model component 32, the scheduling information determined by scheduling information component 34, and/or other information.

External resources 24 include sources of information (e.g., databases, websites, etc.), external entities participating with system 10 (e.g., a medical records system of a health care facility that stores patient census information), one or more servers outside of system 10, a network (e.g., the Internet), electronic storage, equipment related to Wi-Fi technology, equipment related to Bluetooth® technology, data entry devices, and/or other resources. In some implementations, some or all of the functionality attributed herein to external resources 24 may be provided by resources included in system 10. External resources 24 may be configured to communicate with processor 20, computing device 18, electronic storage 22, health care facility 12 and/or unit 14, and/or other components of system 10 via wired and/or wireless connections, via a network (e.g., a local area network and/or the internet), via cellular technology, via Wi-Fi technology, and/or via other resources.

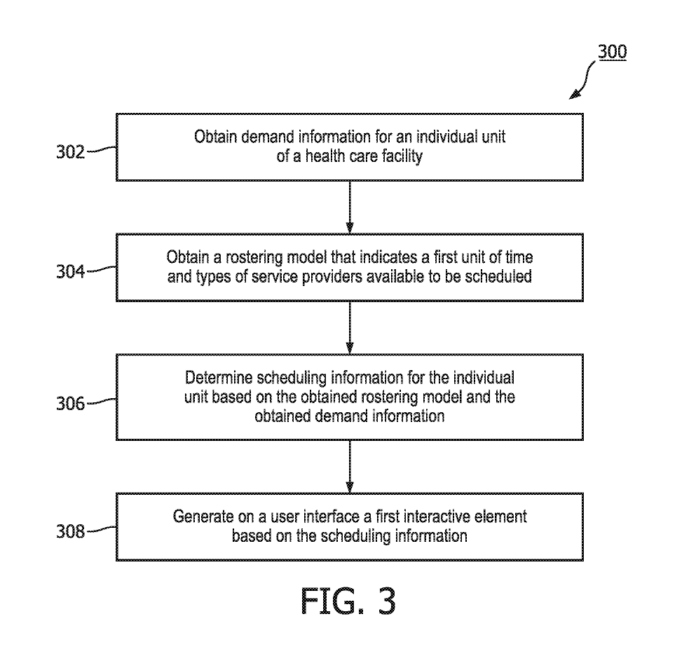

FIG. 3 illustrates a method 300 for facilitating computer-assisted personnel scheduling, in accordance with one or more embodiments. Method 300 may be performed with a personnel scheduling system (e.g., system 10). The system comprises of one or more hardware processors and/or other components. The hardware processors are configured by machine-readable instructions to execute computer program components. The computer program components include a demand information component, a rostering model component, a scheduling information component, a user interface component, and/or other components. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of method 300 in response to instructions stored electronically on an electronic storage medium. The processing devices may include one or more devices configured through hardware, firmware, and/or software to be specifically designed for execution of one or more of the operations of method 300.

At an operation 302, demand information for an individual unit of a health care facility may be obtained. As an example, the demand information may indicate one or more estimated levels of demand for service providers at the individual unit during one or more time periods. The estimated levels of demand may be based on past patient census information indicating one or more quantities of patient visits to the individual unit with respect to one or more past time periods. In some embodiments, operation 302 is performed by a processor component that is the same as or similar to demand information component 30 (shown in FIG. 1 and described herein).

At an operation 304, a rostering model may be obtained. As an example, the rostering model may indicate a first unit of time and types of service providers available to be scheduled for respective different multiples of the first unit of time. In one use case, the first unit of time may be greater than one hour and less than one day. In another use case, the first unit of time may be one day or greater than one day. In another use case, the first unit of time maybe one hour or less than one hour. In some embodiments, operation 304 is performed by a processor component that is the same as or similar to rostering model component 32 (shown in FIG. 1 and described herein).

At an operation 306, scheduling information for the individual unit may be determined based on the rostering model and the demand information. As an example, scheduling information may indicate one or more quantities of service providers to be scheduled for at least one of the different multiples of the first unit of time during the time periods. In some embodiments, operation 306 is performed by a processor component the same as or similar to scheduling information component 34 (shown in FIG. 1 and described herein).

In some embodiments, with respect to operation 306, the determination of the scheduling information may be determined by determining, based on the demand information, without using multiplication operands and without using division operands, the quantities of service providers to be scheduled for at least one of the different multiples of the first unit of time during the time periods. As an example, one or more addition or subtraction operands may be used to update the quantities of service providers to be scheduled without using multiplication operands and without using division operands.

In some embodiments, with respect to operation 306, the determination of the scheduling information may comprise allocating, based on the demand information, service providers of a first service provider type across the time periods. The first service provider type may be a service provider that is available to be scheduled for a first multiple of the first unit of time. The service providers of the first service provider type may be allocated such that a quantity of service providers of the first service provider type allocated satisfies the estimated levels of demand during the time periods. As an example, the allocated quantity of service providers of the first service provider type may satisfy the estimated levels of demand during the time periods responsive to the allocated quantity being within a predefined understaffing threshold and a predefined overstaffing threshold.

In some embodiments, the determination of the scheduling information may comprise iteratively replacing consecutive allocations of service providers of the first service provider type with a service provider of a second service provider type. The second service provider type may be a service provider that is available for a second multiple of the first unit of time different than the first multiple of the first unit of time. In some embodiments, the determination of the scheduling information may comprise, for remaining consecutive allocations of service providers of the first service provider type that have not been replaced after the iterative replacement with a service provider of the second service provider type, iteratively replacing one or more of the remaining consecutive allocations of service providers of the first service provider type with a service provider of a third service provider type. The third service provider type may be a service provider that is available for a third multiple of the first unit of time different than the first multiple of the first unit of time and the second multiple of the first unit of time.

At an operation 308, a first interactive element may be generated on a user interface based on the scheduling information. As an example, the first interactive element may correspond to quantities of service providers to be scheduled. As another example, the first interactive element may be generated on the user interface such that the first interactive element is moveable by a user from a current position of the first interactive element on the user interface to another position on the user interface. In some embodiments, operation 308 is performed by a processor component that is the same as or similar to user interface component 36 (shown in FIG. 1 and described herein).

In some embodiments, method 300 further comprises generating, based on the demand information, a second interactive element on the user interface. As an example, the second interactive element may correspond to the estimated levels of demand. As another example, the second interactive element may be generated on the user interface such that the second interactive element is movable by a user from a current position of the second interactive element on the user interface to another position on the user interface. In some embodiments, the foregoing operation is performed by a processor component the same as or similar to user interface component 36 (shown in FIG. 1 and described herein).

In some embodiments, method 300 further comprises updating the scheduling information. As an example, the scheduling information may be updated responsive to the first interactive element, the second interactive element, and/or other elements being moved from their respective current position on the user interface to another position on the user interface. In some embodiments, the foregoing operation is performed by a processor component the same as or similar to scheduling component 34 (shown in FIG. 1 and described herein). In some embodiments, the updating of the scheduling information may comprise updating quantities of service providers to be scheduled without using multiplication operands and without using division operands. As an example, one or more addition or subtraction operands may be used to update the quantities of service providers to be scheduled without using multiplication operands and without using division operands.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

What is claimed is:

1. A system configured to facilitate computer-assisted personnel scheduling, the system comprising one or more hardware processors configured by machine-readable instructions to:
obtain demand information for an individual unit of a health facility, the demand information indicating one or more estimated levels of demand for a service provider at the individual unit during one or more time periods, and the one or more estimated levels of demand being based on past patient census information indicating one or more quantities of patient visits to the individual unit with respect to one or more past time periods;
obtain a rostering model, the rostering model indicating a first unit of time and types of service providers available to be scheduled for respective different multiples of the first unit of time, the first unit of time being greater than one hour and less than one day;
determine scheduling information for the individual unit based on the rostering model and the demand information, the scheduling information indicating one or more quantities of service providers to be scheduled for at least one of the different multiples of the first unit of time during the one or more time periods; and
generate, based on the scheduling information, a first interactive element on a user interface, the first interactive element corresponding to the one or more quantities of service providers to be scheduled.

2. The system of claim 1, wherein the one or more hardware processors are configured to:
generate the first interactive element on the user interface such that the first interactive element is moveable by a user from a current position of the first interactive element on the user interface to another position on the user interface; and
update the scheduling information responsive to the first interactive element being moved to another position on the user interface.

3. The system of claim 2, wherein the one or more hardware processors are configured to update the scheduling information by updating, using one or more addition or subtraction operands and without using multiplication operands and without using division operands, the one or more quantities of service providers to be scheduled.

4. The system of claim 1, wherein the one or more hardware processors are configured to:
generate, based on the demand information, a second interactive element on the user interface such that the second interactive element is moveable by a user from a current position of the second interactive element on the user interface to another position on the user interface, the second interactive element corresponding to the one or more estimated levels of demand; and
update the scheduling information responsive to the second interactive element being moved to another position on the user interface.

5. The system of claim 4, wherein the one or more hardware processors are configured to update the scheduling information by updating, using one or more addition or subtraction operands and without using multiplication operands and without using division operands, the one or more quantities of service providers to be scheduled.

6. The system of claim 1, wherein the one or more hardware processors are configured to determine the scheduling information by determining, based on the demand information, using one or more addition or subtraction operands and without using multiplication operands and without using division operands, the one or more quantities of service providers to be scheduled for at least one of the different multiples of the first unit of time during the one or more time periods.

7. The system of claim 1, wherein the one or more hardware processors are configured to determine the scheduling information by:
allocating, based on the demand information, service providers of a first service provider type across the one or more time periods such that a quantity of service providers of the first service provider type allocated satisfies the one or more estimated levels of demand during the one or more time periods, the first service provider type being a service provider that is available to be scheduled for a first multiple of the first unit of time; and
iteratively replacing consecutive allocations of service providers of the first service provider type with a service provider of a second service provider type, the second service provider type being a service provider that is available for a second multiple of the first unit of time.

8. The system of claim 7, wherein the one or more hardware processors are configured to determine the scheduling information by:
for remaining consecutive allocations of service providers of the first service provider type that have not been replaced after the iterative replacement with a service provider of the second service provider type, iteratively replacing one or more of the remaining consecutive allocations of service providers of the first service provider type with a service provider of a third service provider type, the third service provider type being a service provider that is available for a third multiple of the first unit of time different than the first multiple of the first unit of time and the second multiple of the first unit of time.

9. The system of claim 8, wherein a service provider of the first service provider type is a service provider that is available to be scheduled for four consecutive hours, a service provider of the second service provider type is a service provider that is available to be scheduled for twelve consecutive hours, and a service provider of the third service provider type is a service provider that is available to be scheduled for eight consecutive hours.

10. The system of claim 7, wherein the allocated quantity of service providers of the first service provider type satisfies the one or more estimated levels of demand during the one or more time periods responsive to the allocated quantity being within a predefined understaffing threshold and a predefined overstaffing threshold.

11. A method for facilitating computer-assisted personnel scheduling, the method being implemented by one or more hardware processors configured by machine-readable instructions, the method comprising:
obtaining demand information for an individual unit of a health facility, the demand information indicating one or more estimated levels of demand for a service provider at the individual unit during one or more time periods, and the one or more estimated levels of demand being based on past patient census information indicating one or more quantities of patient visits to the individual unit with respect to one or more past time periods;
obtaining a rostering model, the rostering model indicating a first unit of time and types of service providers available to be scheduled for respective different multiples of the first unit of time, the first unit of time being greater than one hour and less than one day;
determining scheduling information for the individual unit based on the rostering model and the demand information, the scheduling information indicating one or more quantities of service providers to be scheduled for at least one of the different multiples of the first unit of time during the one or more time periods;
generating, based on the scheduling information, a first interactive element on a user interface, the first interactive element corresponding to the one or more quantities of service providers to be scheduled.

12. The method of claim 11, wherein the first interactive element is generated on the user interface such that the first interactive element is moveable by a user from a current position of the first interactive element on the user interface to another position on the user interface, the method further comprising:
updating the scheduling information responsive to the first interactive element being moved to another position on the user interface.

13. The method of claim 12, wherein updating the scheduling information comprises updating, using one or more addition or subtraction operands and without using multiplication operands and without using division operands, the one or more quantities of service providers to be scheduled.

14. The method of claim 11, wherein determining the scheduling information comprises determining, using one or more addition or subtraction operands and without using multiplication operands and without using division operands, the one or more quantities of service providers to be scheduled for at least one of the different multiples of the first unit of time during the one or more time periods.

15. The method of claim 11, wherein determining the scheduling information comprises:
allocating, based on the demand information, service providers of a first service provider type across the one or more time periods such that a quantity of service providers of the first service provider type allocated satisfies the one or more estimated levels of demand during the one or more time periods, the first service provider type being a service provider that is available to be scheduled for a first multiple of the first unit of time; and
iteratively replacing consecutive allocations of service providers of the first service provider type with a service provider of a second service provider type, the second service provider type being a service provider that is available for a second multiple of the first unit of time different than the first multiple of the first unit of time.

16. A system for facilitating computer-assisted personnel scheduling, the system comprising:
means for obtaining demand information for an individual unit of a health facility, the demand information indicating one or more estimated levels of demand for a service provider at the individual unit during one or more time periods, and the one or more estimated levels of demand being based on past patient census information indicating one or more quantities of patient visits to the individual unit with respect to one or more past time periods;
means for obtaining a rostering model, the rostering model indicating a first unit of time and types of service providers available to be scheduled for respective different multiples of the first unit of time, the first unit of time being greater than one hour and less than one day;
means for determining scheduling information for the individual unit based on the rostering model and the demand information, the scheduling information indicating one or more quantities of service providers to be scheduled for at least one of the different multiples of the first unit of time during the one or more time periods;
means for generating, based on the scheduling information, a first interactive element on a user interface, the first interactive element corresponding to the one or more quantities of service providers to be scheduled.

17. The system of claim 16, wherein the first interactive element is generated on the user interface such that the first interactive element is moveable by a user from a current position of the first interactive element on the user interface to another position on the user interface, the system further comprising:
means for updating the scheduling information responsive to the first interactive element being moved to another position on the user interface.

18. The system of claim 17, wherein updating the scheduling information comprises updating, using one or more addition or subtraction operands and without using multiplication operands and without using division operands, the one or more quantities of service providers to be scheduled.

19. The system of claim 16, wherein determining the scheduling information comprises determining, using one or more addition or subtraction operands and without using multiplication operands and without using division operands, the one or more quantities of service providers to be scheduled for at least one of the different multiples of the first unit of time during the one or more time periods.

20. The system of claim 16, wherein determining the scheduling information comprises:
allocating, based on the demand information, service providers of a first service provider type across the one or more time periods such that a quantity of service providers of the first service provider type allocated satisfies the one or more estimated levels of demand during the one or more time periods, the first service provider type being a service provider that is available to be scheduled for a first multiple of the first unit of time; and
iteratively replacing consecutive allocations of service providers of the first service provider type with a service provider of a second service provider type, the second service provider type being a service provider that is available for a second multiple of the first unit of time different than the first multiple of the first unit of time.
